(19) United States
(12) Patent Application Publication
(10) Pub. No.: US 2007/0138680 A1
(43) Pub. Date: Jun. 21, 2007

(54) METHOD FOR OPERATING AN INJECTION MOLDING MACHINE

(75) Inventor: Gunther Grimm, Hilgertshausen (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GmbH, Munchen (DE)

(21) Appl. No.: 11/673,204

(22) Filed: Feb. 9, 2007

Related U.S. Application Data
(63) Continuation of application No. PCT/EP05/09029, filed on Aug. 20, 2005.

(30) Foreign Application Priority Data
Sep. 8, 2004 (DE) 10 2004 043 300.3

(51) Int. Cl. B29C 45/76

(52) U.S. Cl. 264/40.1; 264/328.1

(57) ABSTRACT

In a method for operating an injection molding machine an actual clamping force is measured during an opening and/or closing movement of a mold half along a travel path. A force pattern of a maximum allowable clamping force and/or a minimum allowable clamping force is predefined along the travel path, and the measured actual clamping force is compared with the maximum and/or minimum clamping forces, respectively. When the actual clamping force surpasses the maximum clamping force or falls short of the minimum clamping force, a time measurement is started, wherein a drive of the mold half is switched off, when the time measurement exceeds a predetermined time duration.

### CROSS-REFERENCES TO RELATED APPLICATIONS

This application is a continuation of prior filed copending PCT International application no. PCT/EP2005/009029, filed Aug. 20, 2005, which designated the United States and has been published but not in English as International Publication No. WO 2006/027100 and on which priority is claimed under 35 U.S.C. §120, and which claims the priority of German Patent Application, Serial No. 10 2004 043 300.3, filed Sep. 8, 2004, pursuant to 35 U.S.C. 119(a)-(d), the contents of which are incorporated herein by reference in its entirety as if fully set forth herein.

### BACKGROUND OF THE INVENTION

The present invention is directed, in general, to a method for operating an injection molding machine. More particularly, the present invention is directed to a method for triggering a tool safety device when the mold opening/closing forces exceed or fall short of specified values for the mold opening/closing forces along the travel path of the movable mold half.

Nothing in the following discussion of the state of the art is to be construed as an admission of prior art.

Published European Pat. Appl. No. EP 1318005 A1 discloses a method for triggering a tool safety device, wherein the movement of a mold half is monitored along a travel path of the mold half. The drive of the mold half is switched off when no or only a minimum motion of the component is detected. This method involves a path-based triggering method for the tool safety, i.e., the drive of the mold half is switched off when a travel distance per unit of time falls short. This method has proven effective. However, with more complicated molding tool designs, for example with an injection molding tool having a plurality of sliders that must be closed when a mold is closed, this method does not always provide the required accuracy. Triggering can be faulty, for example as a result of vibrations of the foundation or shocks in the hydraulic system.

Published European Pat. Appl. No. EP 0180531 discloses an injection molding machine with a mold protection device, having an acceleration sensor which is mounted on the moving mold half. If a delay occurs that exceeds a predetermined value, the closing motion of the clamping cylinder is terminated. This method is suitable only for relatively simple mold designs, e.g., constructed of two mold halves without slider, because the closing movement in such molds can follow a simple pattern. More complex molds with one or more sliders do not have a constant closing operation with respect to acceleration. The method disclosed in EP 0158031 may therefore produce unwanted false alarms, causing interruption of the closing movement of the mold and hence the operation of the injection molding machine.

Published European Pat. Appl. No. EP 0203199 B1 discloses a time-based tool safety system, which is based on the concept that for a preset clamping force the mold half to be moved must travel a predetermined distance within a predetermined time. If the mold half fails to arrive within the predetermined time at a checkpoint at the end of the closing path, the presence of a malfunction is assumed and the closing motion is interrupted. This method has the disadvantage that it can be easily manipulated by an operator. For example, the operator can increase the clamping force when the travel time approaches the critical time, e.g., due to increased friction, and thereby prevent triggering of the alarm. Such improper manipulation is undesirable.

It would therefore be desirable and advantageous to provide an improved method for operating an injection molding machine device, which obviates prior art shortcomings and is able to specifically prevent false alarms by identifying small, short-time failures during the mold clamping phase, which are not caused by a critical error, and to refrain from switching off the injection molding machine when such failure occurs.

### SUMMARY OF THE INVENTION

According to one aspect of the invention, a method for operating an injection molding machine, includes the steps of measuring an actual clamping force during an opening and/or closing movement of a mold half along a travel path of the mold half, comparing the actual clamping force with a force pattern of a desired clamping force defined along the travel path, predefining an admissible time duration by which the actual clamping force is permitted to deviate from the desired clamping force, and determining the duration of a time period by which the actual clamping force deviates from the desired clamping force, switching off a drive of the mold half, when the time period exceeds the admissible time duration.

According to another feature of the present invention, the desired clamping force may be a maximum allowable clamping force, wherein the drive is switched off when the actual clamping force surpasses the maximum allowable clamping force for a time period exceeding the admissible time duration, and/or a minimum allowable clamping force, wherein the drive is switched off when the actual clamping force falls short of the minimum allowable clamping force for a time period exceeding the admissible time duration.

In other words, the instantaneous clamping force (actual clamping force) can be measured along the entire closing and/or opening movement of a molding tool of an injection molding machine, e.g., of a mold half. The actual clamping force is then compared with a desired clamping force. If the actual clamping force surpasses a maximum allowable clamping force, which is composed of the desired clamping force and a tolerance force, a time measurement starts at the point in time when the actual clamping force surpasses the maximum clamping force. When the time duration of the excessive actual force is smaller than a predetermined time value, the closing movement of the mold will not be interrupted, even though the maximum allowable force has been surpassed. The drive for the molding tool or the mold half is switched off only when the actual force surpasses in a predetermined operating state the maximum allowable clamping force for a longer time than a predetermined time duration.

The method according to the invention involves also a comparison of the instantaneous clamping force with a desired clamping force. In addition, a minimum clamping force can be defined which is determined from a combination of the desired clamping force and a tolerance force. If the instantaneous clamping force falls below the minimum allowable clamping force, a time measurement commences from the point in time when the actual clamping force falls below the minimum allowable clamping force. When the time duration that the actual force is deficient is smaller than a predetermined time value, the closing movement of the mold will not be interrupted even though the minimum allowable force has not been reached. The drive for the molding tool or the mold half is switched off only when the actual force falls below the minimum allowable clamping force in a predetermined operating state for a longer time than a predetermined time duration.

The predetermined time duration may be specific for a molding tool, and may be in a range of between about 0.1 and about 0.6 seconds.

With the method of the invention, short-term force peaks, which may be encountered, e.g., as a result of vibrations in the foundation caused by adjacent machines, can advantageously be filtered out, without causing the drives and hence of the injection molding machine to be inadvertently switched off. Another advantage is that the tolerated force region can be selected to be relatively small, without the risk of damaging a molding tool.

According to another feature of the present invention, the travel path can be divided into a plurality of zones, wherein the tolerance clamping force may be constant within a zone. The zones can be relatively small, which lessens the risk of damaging a molding tool.

According to another feature of the present invention, tool wear can be detected early by evaluating the actual force curve and by evaluating the time durations during which the maximum force is exceeded. This can prevent damage to a molding tool by performing maintenance works before the damage actually occurs.

According to another feature of the present invention, the maximum or minimum travel force may act on the mold halves only for a short time, thereby minimizing possible damage to the molding tool or the molded part. In addition, the tolerance clamping force can advantageously be defined either as a fixed value or as a percentage of a desired clamping force applied during an opening and/or closing movement of the mold half along the travel path of the mold half. This value or percentage can be selected to be quite small, thereby also minimizing possible damage to the molding tool or the molded part.

### BRIEF DESCRIPTION OF THE DRAWING

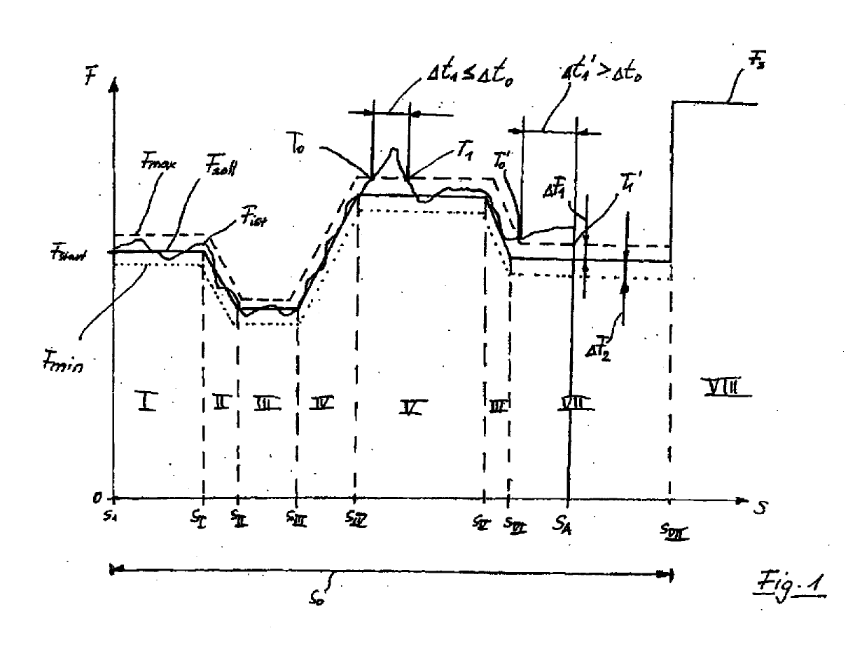

Other features and advantages of the present invention will be more readily apparent upon reading the following description of currently preferred exemplified embodiments of the invention with reference to the accompanying drawing, in which the sole FIG. 1 shows schematically a diagram of the force pattern F as a function of the closing path of an injection mold half.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

FIG. 1 shows schematically a force pattern along a closing path So of a mold half. The closing path So is divided in the example of FIG. 1 into zones I to VII. A solid line consisting, for example, of straight line segments represents a desired clamping force Fₛₒₗₗ and its course along a closing path S₀.

A broken line which extends parallel to and is, in particular offset from the solid line of the desired clamping force Fₛₒₗₗ, represents a maximum allowable clamping force Fₘₐₓ. The course of the broken line of the maximum allowable force Fₘₐₓ is offset upwards by an amount ΔF in relation to the line of the desired clamping force Fₛₒₗₗ. The travel points at the end of each of the zones I to VII are labeled with S_{I} to S_{VII}.

The desired clamping force Fₛₒₗₗ has, for example, the value Fₛₜₐᵣₜ in zone I. The desired clamping force Fₛₒₗₗ decreases, for example, linearly to a lower value in zone II. In zone III, the desired clamping force Fₛₒₗₗ remains constant at the lower level, and increases, for example, in zone IV linearly to a desired clamping force Fₛₒₗₗ, which is greater than the desired starting clamping force Fₛₜₐᵣₜ. In the region of zone V, the desired clamping force Fₛₒₗₗ is horizontal and subsequently decreases again within the zone VI, for example linearly, to a lower-level. In zone VII, the desired clamping force extends again constant up to the closing point S_{VII}, when the mold halves contact each other. The desired clamping force subsequently increases to reliably provide the clamping pressure for the molding tool. After the clamping force has been reached, the plastic injection molding process can begin within the zone VII.

The method according to the invention for operating an injection molding machine relates to the closing and/or opening movement of the plastics injection molding tool within the exemplary zones I to VII. Within each of the zones I to VII, a maximum allowable clamping force Fₘₐₓ is respectively associated with the desired clamping force Fₛₒₗₗ. The maximum allowable clamping force Fₘₐₓ is greater by an amount ΔF₁ than the desired clamping force Fₛₒₗₗ. In the exemplary embodiment of FIG. 1, the amount ΔF₁ is identical in each of the seven zones I to VII. Of course, the amount ΔF₁ may also be different in each of the zones I to VII, or may even have different values within a zone. The amount ΔF₁ is hereby selected such that the actual mold clamping force Fᵢₛₜ is always in a region between the lines Fₘₐₓ and Fₛₒₗₗ during a failure-free operation with an intact molding tool.

According to the invention, the actual clamping force Fᵢₛₜ is continuously measured during the entire closing and/or opening process of the plastics injection molding tool. So long as Fᵢₛₜ≦Fₘₐₓ, the closing or opening process of the plastics injection mold operates within the predetermined tolerances and is therefore fault-free.

Malfunctions during operation may cause the actual clamping force Fᵢₛₜ to exceed the maximum allowable value for the clamping force Fₘₐₓ. Such an exemplary event is illustrated in FIG. 1 within the zone V, within which the line of the actual clamping force Fᵢₛₜ exceeds the maximum allowable clamping force Fₘₐₓ at the point T₀. According to the invention, as soon as this happens, the time duration Δt₁ is measured within which the actual clamping force Fᵢₛₜ is greater than the maximum allowable clamping force Fₘₐₓ.

So long as the malfunction which caused the excessive clamping force lasts only for a short time, for example as a consequence of vibrations of the foundation or the like, the time duration between the point T₀ of surpassing the maximum allowable clamping force Fₘₐₓ and the point T₁ when the maximum allowable clamping force Fₘₐₓ falls again below the maximum allowable clamping force Fₘₐₓ is a time duration Δt₁ which is shorter than a critical time duration Δt₀.

The critical time duration Δt₀ is a predetermined, mold-specific limit value which can be, for example, a preselected, fixed empirical value. Suitable values for Δt₀ are in a range between 0.1 s≦Δt₀≦0.6 s.

So long as a time duration Δt₁ during which the clamping force Fᵢₛₜ is greater than the maximum allowable Fₘₐₓ, is shorter than the critical time duration Δt₀, the drive for closing the plastics injection molding tool is not switched off. The closing operation continues even though the maximum allowable clamping force Fₘₐₓ has been briefly surpassed.

However, if the actual clamping force Fᵢₛₜ is excessive for a time period that lasts longer than the predetermined tolerance value Δt₀, the presence of a malfunction is assumed which can damage the plastics injection molding tool or molded part. The drive for the moving half of the injection molding tool is then switched off.

Such an exemplary condition is indicated within zone VII in FIG. 1. At the time T₀′, the actual clamping force Fᵢₛₜ exceeds the maximum allowable clamping force Fₘₐₓ. The time by which the maximum clamping force has been surpassed is measured starting from the point in time T₀′. As soon as the time duration of surpassing (here Δt₁′) is greater than Δt₀, the drive of the mold half is switched off. In this situation, the mold half remains stationary at a location Sᵢ. The corresponding clamping force abruptly drops to a value of zero.

This guarantees that the drive of the mold drive is switched off, when the clamping force surpasses Fₘₐₓ and at the same time for a period that lasts longer than a predetermined time duration Δt₀.

The mold is thus, on one hand, reliably protected against overstress, for example, due to obstacles in the travel path or locking and/or jamming when the sliders are closed. On the other hand, short-term, uncritical faults during operation which cause the clamping force to be excessive for a brief time will not trigger an inadvertent stoppage of the mold. This significantly increases the uptime of an injection molding machine operating according to the method of the invention.

Of course, it is also within the scope of the invention to optionally define a minimum clamping force Fₘᵢₙ which extends downwardly offset by an amount ΔF₂ in relation to the Fₛₒₗₗ line (dotted line in FIG. 1).

In analogy to surpassing the clamping force Fₘₐₓ during a certain critical time duration, the drive of the molding tool can also be switched off in accordance with the invention, when the clamping force Fₘᵢₙ falls short for a certain minimum time duration Δt₀′. Falling below a minimum clamping force Fₘᵢₙ can occur, for example, if a slider which should be moved conjointly during the closing action, is not gripped when the molding tool is closed, so that the mold is not properly closed. A slider that is not captured can cause, for example, the clamping force Fᵢₛₜ in one of the zones I to VII to be lower than the minimum clamping force Fₘᵢₙ. In addition, during a break-in of a new mold, this mold may be “easier to close” or “easier to open”, so that a situation in which the minimum clamping force Fₘᵢₙ has frequently not been reached can be interpreted as an indication that the break-in phase of a plastics injection mold has been completed. In this case, the desired clamping force curve Fₛₒₗₗ together with the maximum clamping force curve Fₘₐₓ may be decreased. This enhances the operational safety of the molding tool during subsequent operation, because following a correction of the maximum allowable clamping force curve Fₘₐₓ, the clamping force excesses lasting longer than Δt₀ are again better suited to the actual instantaneous mold closing characteristic, and a mold-specific emergency stop is triggered more accurately.

It is, of course, also within the scope of the invention to define the tolerance values ΔF₁ and ΔF₂ between the desired clamping force Fₛₒₗₗ and the maximum and minimum clamping force Fₘₐₓ and Fₘᵢₙ, respectively, as a fixed force value, or to select the values ΔF₁ and ΔF₂ as a percentage deviation from the respective value Fₛₒₗₗ.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating an injection molding machine, comprising the steps of:
measuring an actual clamping force during an opening and/or closing movement of a mold half along a travel path of the mold half;
comparing the actual clamping force with a force pattern of a desired clamping force defined along the travel path;
predefining an admissible time duration by which the actual clamping force is permitted to deviate from the desired clamping force;
determining the duration of a time period by which the actual clamping force deviates from the desired clamping force; and
switching off a drive of the mold half, when the time period exceeds the admissible time duration.

2. The method of claim 1, wherein the desired clamping force is a maximum allowable clamping force, wherein the drive is switched off when the actual clamping force surpasses the maximum allowable clamping force for a time period exceeding the admissible time duration.

3. The method of claim 1, wherein the desired clamping force is a minimum allowable clamping force, wherein the drive is switched off when the actual clamping force falls short of the minimum allowable clamping force for a time period exceeding the admissible time duration.

4. The method of claim 2, wherein the maximum allowable clamping force is defined as a sum of a desired clamping force and a tolerance clamping force.

5. The method of claim 3, wherein the minimum allowable force is defined as a difference between a desired clamping force and a tolerance clamping force.

6. The method of claim 4, further comprising dividing the travel path into a plurality of zones, wherein the tolerance clamping force is constant within a zone.

7. The method of claim 5, further comprising dividing the travel path into a plurality of zones, wherein the tolerance clamping force is constant within a zone.

8. The method of claim 4, wherein the tolerance clamping force has a predetermined value.

9. The method of claim 5, wherein the tolerance clamping force has a predetermined value.

10. The method of claim 4, wherein the tolerance clamping force is defined as a percentage of a desired clamping force applied during an opening and/or closing movement of the mold half along the travel path of the mold half.

11. The method of claim 5, wherein the tolerance clamping force is defined as a percentage of a desired clamping force applied during an opening and/or closing movement of the mold half along the travel path of the mold half.

12. The method of claim 1, wherein the admissible time duration is defined specific for a molding tool.

13. The method of claim 1, wherein the admissible time duration is in a range between about 0.1 and about 0.6 seconds.

14. A method for operating an injection molding machine, comprising the steps of:
measuring an actual clamping force during an opening and/or closing movement of a mold half along a travel path of the mold half;
comparing the actual clamping force with a force pattern of a maximum allowable clamping force defined along the travel path;
starting a time measurement when the actual clamping force surpasses the maximum allowable clamping force; and
switching off a drive of the mold half, when the time measurement exceeds a predetermined time duration.

15. A method for operating an injection molding machine, comprising the steps of:
measuring an actual clamping force during an opening and/or closing movement of a mold half along a travel path of the mold half;
comparing the actual clamping force with a force pattern of a minimum allowable clamping force defined along the travel path;
starting a time measurement when the actual clamping force falls short of the minimum allowable clamping force; and
switching off a drive of the mold half, when the time measurement exceeds a predetermined time duration.

16. A method for operating an injection molding machine, comprising the steps of:
measuring an actual clamping force during an opening and/or closing movement of a mold half along a travel path of the mold half;
comparing the actual clamping force with a force pattern of a maximum allowable clamping force along the travel path and a minimum allowable clamping force defined along the travel path;
starting a time measurement when the actual clamping force surpasses the maximum allowable clamping force or when the actual clamping force falls short of the minimum allowable clamping force; and
switching off a drive of the mold half, when the time measurement exceeds a predetermined time duration.
